(19) United States
(12) Patent Application Publication
(10) Pub. No.: US 2013/0066656 A1
(43) Pub. Date: Mar. 14, 2013

(54) SYSTEM AND METHOD FOR CALCULATING AN INSURANCE PREMIUM BASED ON INITIAL CONSUMER INFORMATION

(71) Applicants: Laura O'Connor Hanson, Manchester, CT (US); Brian Michael Ignatowicz, Manchester, CT (US)

(72) Inventors: Laura O'Connor Hanson, Manchester, CT (US); Brian Michael Ignatowicz, Manchester, CT (US)

(21) Appl. No.: 13/230,141

(22) Filed: Sep. 12, 2011

(51) Int. Cl. G06Q 40/00

(52) U.S. Cl. 705/4

(57) ABSTRACT

According to some embodiments, initial consumer information may be received from a remote consumer device associated with a potential consumer. For example, the potential consumer might provide his or her name and address via a web page. According to some embodiments, the initial consumer information does not include vehicle information. Responsive to the initial consumer information, supplemental information may be automatically requested from a third-party data source. The supplemental information, including vehicle information associated with the potential consumer, may then be received from the third-party data source. An automobile insurance premium may then be calculated for the potential consumer based at least in part on the supplemental information. At least one potentially binding insurance quote may then be transmitted to the remote consumer device based on the calculated automobile insurance premium.

### BACKGROUND

A consumer may access a remote automobile insurance platform to investigate various aspects of a potential automobile insurance policy. For example, a consumer might visit an insurer's web site to determine a yearly or monthly cost of an insurance policy (e.g., hoping to save money or increase a level of protection by selecting a new insurance company). Before an appropriate premium price or “quote” for a potential consumer can be determined, however, the potential insurer will need to learn relatively detailed information about that consumer. By way of examples, the insurer may need to determine how many vehicles the consumer owns, the manufacturer, model, and year of manufacture of each vehicle, other members of the consumer's household who might also drive those vehicles, the consumer's driving history, etc. Only after such information is determined by the insurer can an appropriate risk analysis, underwriting decision, and/or premium pricing process be performed.

Entering this information, however, can be a time consuming and error prone process for the consumer. For example, the consumer might need to enter his or her name and address, each vehicle's Vehicle Identification Number (VIN), an accurate summary of his or her driving history, etc. In some cases, a consumer might even be unaware of various information being requested by the insurer (e.g., his or her currently automobile insurance coverage limits or credit score). As a result, many consumers may abandon their investigation of potential automobile insurance policy options before learning what the premium would be.

It would be desirable to provide systems and methods to calculate an automobile insurance premium for a consumer in an automated, efficient, and accurate manner.

### SUMMARY OF THE INVENTION

According to some embodiments, systems, methods, apparatus, computer program code and means may be provided to automatically calculate an automobile insurance premium for a consumer in an efficient and accurate manner In some embodiments, a communication device may receive initial consumer information, wherein the initial consumer information does not include vehicle information. Responsive to the initial consumer information, supplemental information may be automatically requested from a third-party data source. The supplemental information, including vehicle information associated with the potential consumer, may then be received from the third-party data source. An automobile insurance premium for the potential consumer may then be automatically calculated based at least in part on the supplemental information. According to some embodiments, at least one potentially binding insurance quote is transmitted to the remote consumer device based on the calculated automobile insurance premium.

A technical effect of some embodiments of the invention is an improved and computerized method of calculating an automobile insurance premium for a consumer. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a system according to some embodiments of the present invention.

FIG. 2 illustrates a method according to some embodiments of the present invention.

FIG. 3 is a flow diagram of a method that considers a strength of correlation between initial consumer information and supplemental information in accordance with some embodiments of the present invention.

FIGS. 4 through 6 illustrate examples of displays on a mobile device according to some embodiments.

FIG. 7 is a flow diagram of an “assess and test” method in accordance with some embodiments of the present invention.

FIG. 8 illustrates a method according to some embodiments of the present invention.

FIG. 9 illustrates various work flows associated with some embodiments disclosed herein

FIG. 10 is an example of an automobile insurance platform according to some embodiments.

FIG. 11 is a tabular portion of a consumer information database according to some embodiments.

FIG. 12 is block diagram of a system according to some embodiments of the present invention.

FIG. 13 illustrates a display that might be provided in accordance with some of the embodiments disclosed herein.

### DETAILED DESCRIPTION

A consumer may access an automobile insurance platform to investigate various aspects of a potential automobile insurance policy. Although some examples described herein are associated with automobile insurance, note that embodiments can be associated with other types of insurance (e.g., homeowners insurance, commercial insurance, workers compensation, etc.). Before an appropriate premium quote for a potential consumer can be determined, however, the potential insurer needs to determine detailed information about that consumer, such as how many vehicles the consumer owns, the manufacturer, model, and year of manufacture of each vehicle, other members of the consumer's household who might also drive those vehicles, etc. This information may then be used by the insurer to calculate an appropriate premium price.

Entering this information, however, can be inconvenient, and, as a result, consumers may abandon their investigation of insurance policy options before receiving a premium quote.

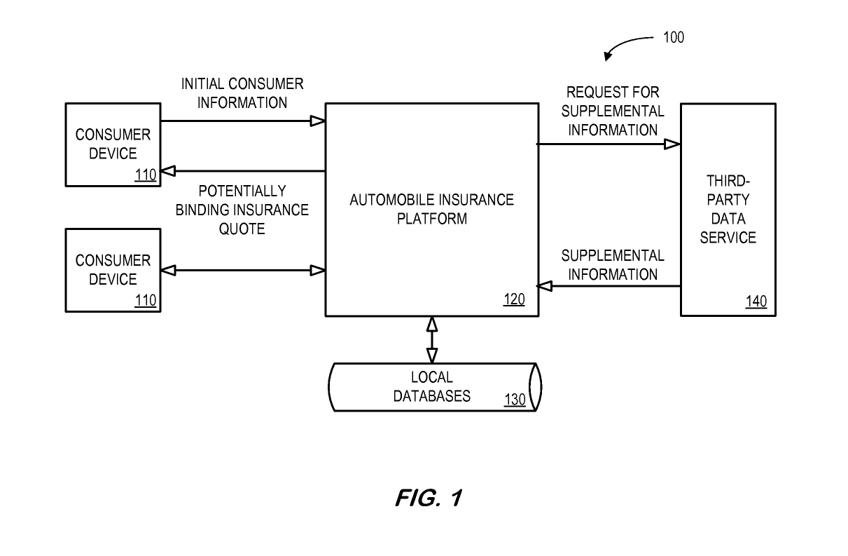

To help provide accurate premium quotes to potential consumers relatively quickly, FIG. 1 is a block diagram of a system 100 according to some embodiments of the present invention. The system 100 may, for example, facilitate the calculation of an automobile insurance premium for a potential consumer. According to some embodiments, an automobile insurance platform 120 may receive information from remote consumer devices 110. The automobile insurance platform 120 might be associated with, for example, an insurance company, an insurance broker, or an entity that provides consumers with quotes from multiple insurance companies. The consumer devices 110 might comprise, for example, Personal Computers (PCs), laptop computers, hand-held computers, wireless devices, smartphones, set-top boxes, and/or kiosks (e.g., at an automobile dealership) that can transmit information to and receive information from the automobile insurance platform 120. By way of example, a consumer device 110 might be associated with a consumer's home computer, vehicle computer, or smartphone executing a browser that exchanges information with a web server associated with the automobile insurance platform.

According to some embodiments, an “automated” automobile insurance platform 120 may facilitate a calculation of an automobile insurance premium. As used herein, the term “automated” may refer to, for example, actions that can be performed with little or no human intervention. By way of example only, the automobile insurance platform 120 may include and/or communicate with a PC, an enterprise server, or a database farm. According to some embodiments, the automobile insurance platform 120 is associated with a salesforce automation, a Customer Relationship Management (CRM) application, a Customer Service Manager (CSM)/content management system such as interwoven, Fatwire, etc. The automobile insurance platform 120 may, according to some embodiments, be associated with an insurer that issues automobile insurance policies to consumers and may include business logic and rules associated with an underwriting process.

As used herein, devices, including those associated with the automobile insurance platform 120 and any other device described herein, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

The automobile insurance platform 120 may also access information in one or more local databases 130. The local databases 130 may include, for example, policy holder information, consumer data, and/or underwriting weighting factors and/or formulas. As will be described further below, the local databases 130 may be used by the automobile insurance platform 120 to help determine an appropriate premium price for potential consumers.

Although a single automobile insurance platform 120 is shown in FIG. 1, any number of such devices may be included. Moreover, various devices described herein might be combined according to embodiments of the present invention. For example, in some embodiments, the automobile insurance platform 120 and local databases 130 might be co-located and/or may comprise a single apparatus.

According to some embodiments, the automobile insurance platform 110 may also exchange information with a remote third-party data source 140. The remote third-party data source might, for example, be associated with a governmental Department of Motor Vehicle (DMV) server.

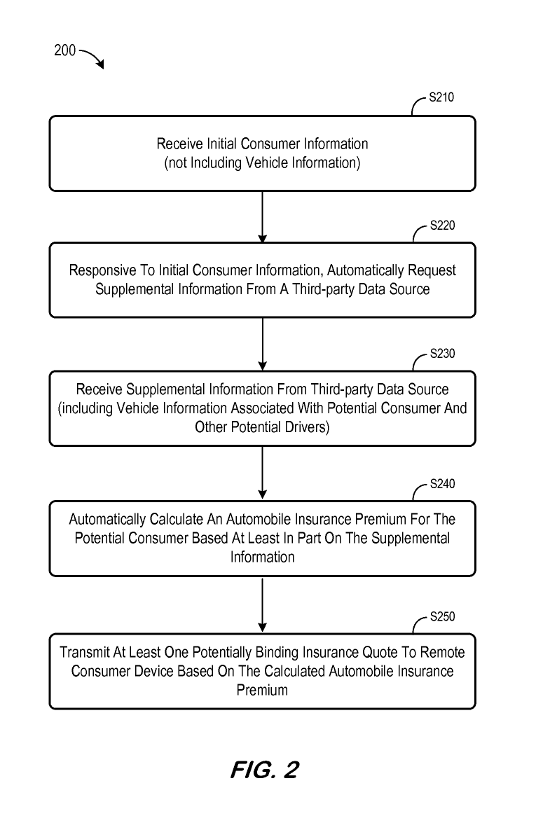

FIG. 2 illustrates a method that might be performed, for example, by some or all of the elements of the system 100 described with respect to FIG. 1 according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, initial consumer information is received, and the initial consumer information does not include vehicle information. The initial consumer information might include, for example, a consumer's name, postal address, ZIP code, at least a portion of a Social Security number (e.g., the last four digits of his or her Social Security number), date of birth, telephone number, email address, and/or user name and password. According to some embodiments, the initial consumer information includes two independent types of data (e.g., a ZIP code and date of birth).

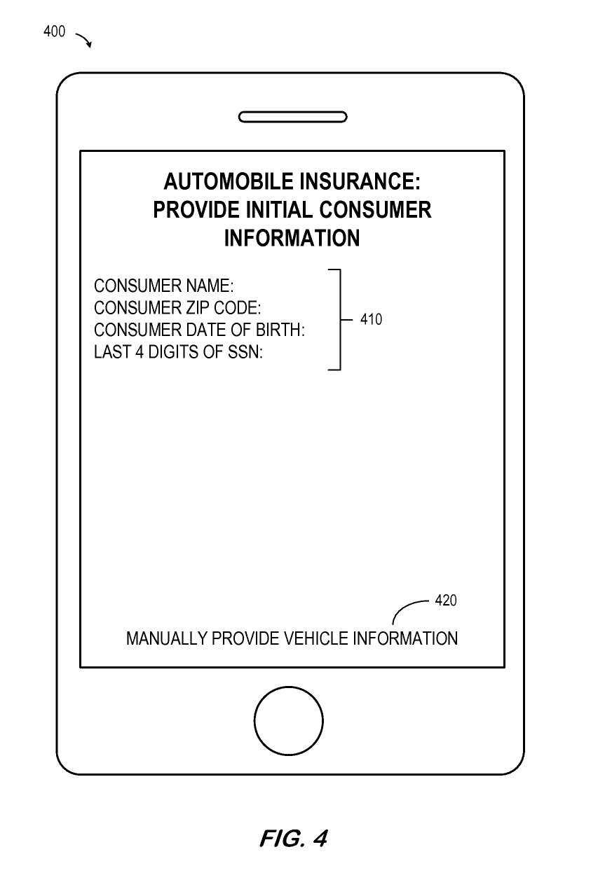

For example, FIG. 4 is an example of a display on a mobile device 400 according to some embodiments. The mobile device 400 may be any of a number of different types of mobile devices that allow for wireless communication and that may be carried with or by a user. For example, in some embodiments, mobile device 400 is an iPhone® from Apple, Inc., a BlackBerry® from RIM, a mobile phone using the Google Android® operating system, a portable or tablet computer (such as the iPad® from Apple, Inc.), a mobile device operating the Android® operating system or other portable computing device having an ability to communicate wirelessly with a remote entity such as a social network server and/or a social media accelerator platform or engine. According to some embodiments, the display includes an input area 410 where a potential consumer can enter his or her name, ZIP code, date of birth, and a portion of his or her Social Security number (e.g., via a keyboard attached to the mobile device 400 or a touch screen). Moreover, the display may include an option 420 selectable by a consumer who prefers to instead manually enter vehicle information.

Referring again to FIG. 2, at S220 the process may automatically request supplemental information from a third-party data source in response to the receipt of the initial consumer information. For example, the automobile insurance platform 120 in the system of FIG. 1 may receive initial consumer information (not including vehicle information) from a consumer device 110 and, in turn, request supplemental information from a third-party data service 140 (e.g., from a DMV server). According to some embodiments, the supplemental information further includes data about additional drivers who may be also associated with an automobile insurance policy.

At S230, supplemental information may be received from the third-party data source, the supplemental information including vehicle information associated with the potential consumer. For example, the automobile insurance platform 120 may receive supplemental information from the third-party data service 140 that includes at least one VIN and a total number of vehicles associated with the potential consumer's household. In addition to vehicle information, the supplemental information might further include insurance information (e.g., the potential consumer's current insurance coverage), violation information (e.g., a number of “points” associated with the consumer's driver's license), accident information, loss information, information about other drivers associated with the potential consumer, credit score information, and/or income information.

At S240, an automobile insurance premium may be automatically calculated for the potential consumer based at least in part on the supplemental information. For example, the automobile insurance platform 120 may automatically calculate a monthly insurance premium for the consumer based on the supplemental information and an affiliation between the potential consumer and a group (e.g., whether or not the consumer is a member of a the Sierra club) and/or another insurance policy associated with the potential consumer (e.g., whether or not the consumer also has a homeowner's insurance policy with the same insurer as determined from the local databases 130).

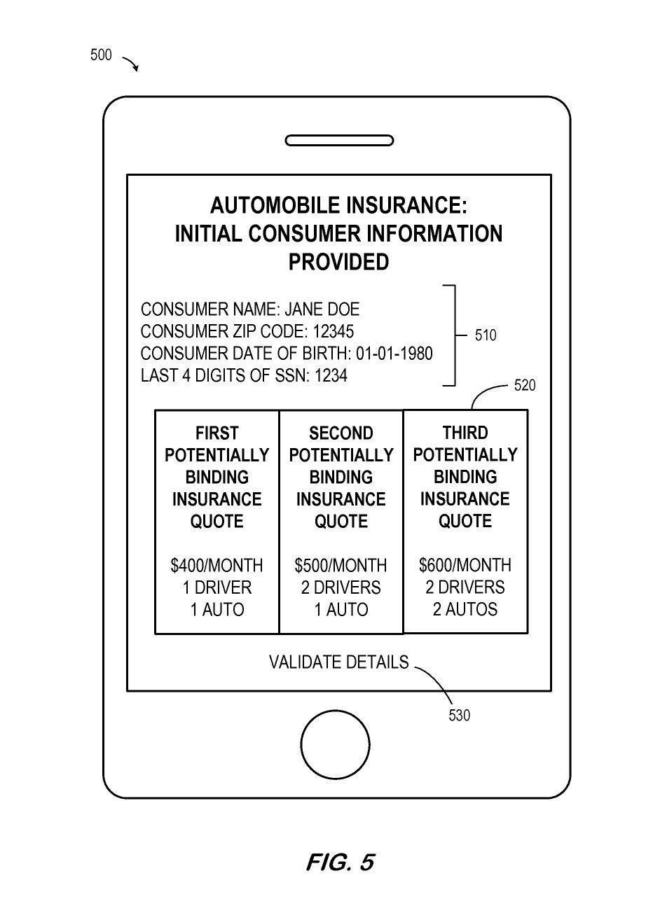

At S250, at least one “potentially binding” insurance quote may be transmitted to the remote consumer device based on the calculated automobile insurance premium. As used herein, the phrase “potentially binding” may refer to an offer that may be binding if the potential consumer does not alter the supplemental information received from one or more third-party services. That is, if the consumer indicates that he or she has recently purchased a new vehicle, an initially presented insurance quote may need to be re-calculated. According to some embodiments, the automobile insurance platform 120 of FIG. 1 might transmit a set of potentially binding insurance quotes to the consumer device 110. For example, FIG. 5 is an example of a display on a mobile device 500 according to some embodiments wherein a consumer has entered his or her initial consumer information via an input portion 510 of the display. Responsive to that information (which did not include vehicle information), a set of three potentially binding quotes 520 are displayed. Moreover, the display may include an option 530 selectable by a consumer who would like to review and/or validate the details behind those quotes (including the automatically determined vehicle information).

By calculating and displaying these potentially binding quotes 520 to the consumer before he or she entered vehicle information, some embodiments of the present invention may increase the likelihood that the consumer will eventually purchase the automobile policy from the insurer.

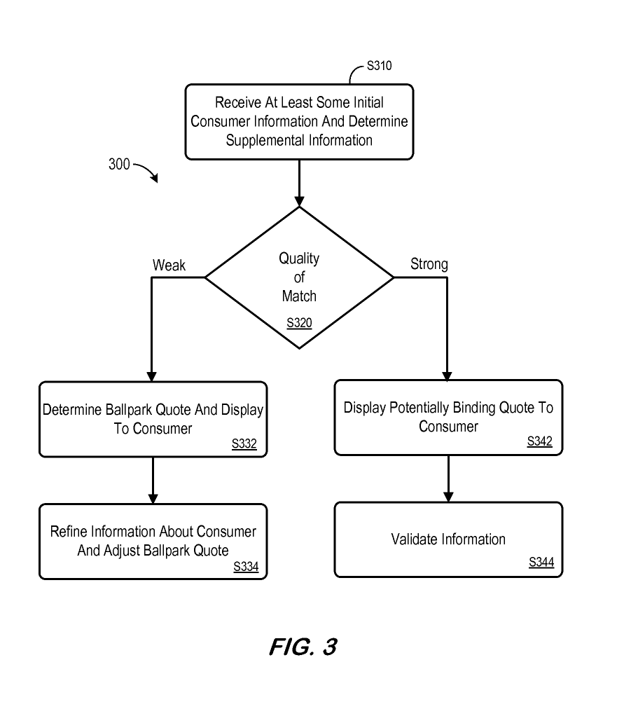

Note that in some cases, it may not be possible to generate a potentially binding quote for a potential consumer. For example, FIG. 3 is a flow diagram of a method 300 that considers a strength of correlation between initial consumer information and supplemental information in accordance with some embodiments of the present invention. At S310, at least some initial consumer information may be received and supplemental information may be determined The quality of a match between the consumer information and the supplemental information may then be determined at S320. For example, if the consumer has only provided his or her ZIP code at S310, then certain assumptions might be made about risk factors (e.g., an average level of income or vehicle value might be known based on the ZIP code). In this case, it might be determined that there is only a weak correlation between the initial consumer information and the supplemental information (that is, the consumer's actual income could vary widely from the average information in that ZIP code). As a result, an estimated or ballpark quote might be determined at S332. The consumer might refine his or her information with more specific data and, as a result, the ballpark quote may be refined at S334.

In other cases, the consumer might have initially provided more detailed information. For example, the consumer might have provided his or her name, address, date of birth, and the last four digits of his or her Social Security number. In that example, it might be determined at S320 that there is a strong correlation between the initial consumer information and the supplemental information (that is, it might be highly likely that records retrieved from a DMV server are actually associated with that particular consumer). As a result, a potentially binding quote might be calculated at S342 and displayed to the consumer. The consumer may then validate the information at S344.

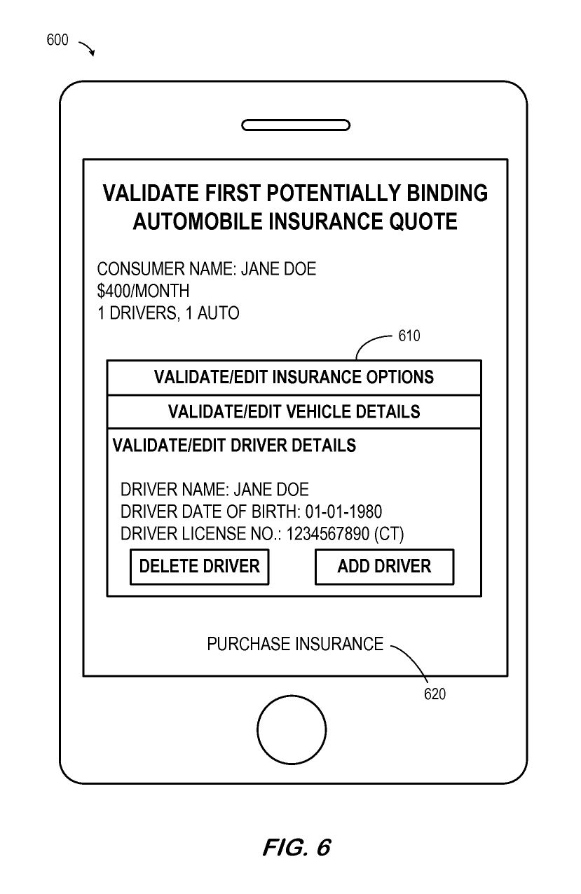

Note that that after one or more potentially binding quotes are provided to the consumer, the system may also facilitate an acceptance of the binding insurance quote by the consumer via the remote consumer device, and eventually issue an automobile insurance policy to the consumer. As part of that process, the consumer may review and/or validate information that was used to generate the potentially binding quotes. For example, FIG. 6 is an example of a display on a mobile device 600 according to some embodiments wherein a consumer interacts with a validation area 610 where he or she can review pre-populated in fields of an insurance application form displayed on the mobile device 600. The validation area 610 might include, for example, insurance options (e.g., coverage limits and deductibles), vehicle details (e.g., VINs, makes, and models), and/or driver details (e.g., driver license numbers) in pre-populated fields.

According to some embodiments, the consumer may use the validation area 610 to provide an adjustment of at least one of the pre-populated fields (e.g., to correct his or her date of birth) and, responsive to the adjustment the system may automatically calculate a modified automobile insurance premium for the potential consumer. A modified potentially binding insurance quote might then be displayed to consumer based on the modified automobile insurance premium. The display may also include an option 620 selectable by a consumer who would like to provide payment and purchase the automobile insurance policy.

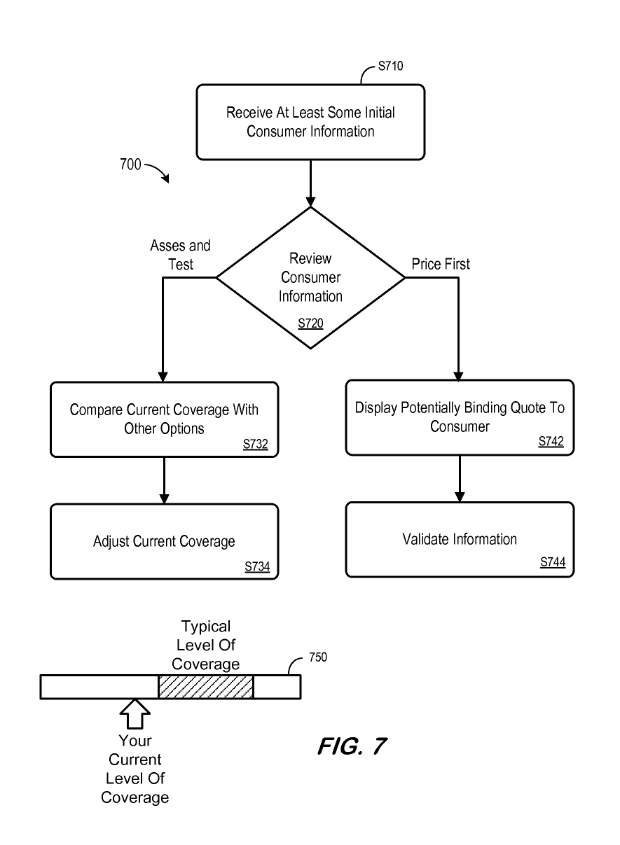

In some cases, a consumer might not be interested in receiving a potentially binding quote at the start of his or her interaction with an insurance platform. For example, certain types of consumers may be more interested in a level of insurance coverage as compared to the price of an insurance premium. FIG. 7 is a flow diagram of an “assess and test” method in accordance with some embodiments of the present invention. At S710, at least some initial consumer information is received. The consumer information may then be automatically reviewed by the insurance platform at S720. Based on that review (e.g., because the consumer is over 65 years old), it might be determined that it is likely that he or she is most interest in an amount of insurance coverage. As a result, the insurance platform might compare his or her current coverage with other insurance options at S732. For example, a display 750 might indicate a range of typical coverage levels along with a visual indication of the consumer's current level of coverage. The consumer may then adjust that level of coverage at S734 if desired (e.g., an “assess and test” option associated with coverage limits, deductibles, etc.).

In other cases, it might be determined at S720 that the consumer is probably more interested in insurance prices as compared to coverage levels. As a result, a potentially binding quote might be calculated at S742 and displayed to the consumer (e.g., a “price first” option). The consumer may then validate the information at S744. Note that the review and determination performed at S720 might be automatically altered based on how consumers are reacting to the various options.

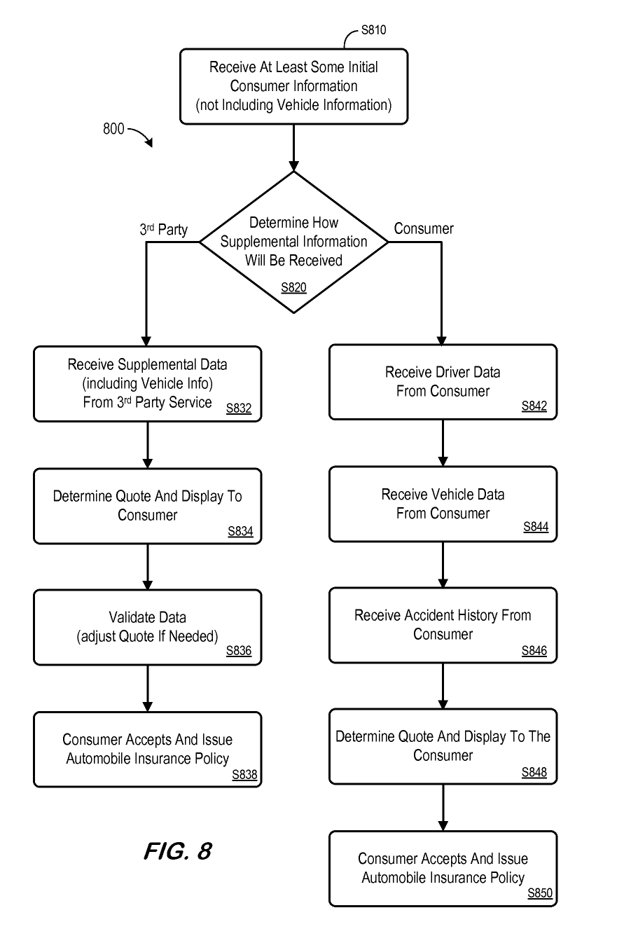

Note that in some cases, the system might not be able to determine any supplemental information for a consumer using a third-party data service (e.g., when the consumer has recently changed his or her address). Moreover, some consumers might prefer to not enter the initial consumer information (e.g., as a result of privacy concerns). FIG. 8 illustrates a method 800 according to some embodiments of the present invention. At S810, at least some initial consumer information (not including vehicle information) may be received. In this case, the at least some initial consumer information might simply include a link selected by the consumer to reach the insurer's web page. For example, the consumer might have reached the insurer's web page via a link from the American Automobile Association (“AAA”) web site.

At S820, a decision engine may automatically determine whether the supplemental information is to be received from the third-party data source or the remote consumer device. The determination at S820 might be based at least in part on, for example, an affiliation between the potential consumer and a group (e.g., the consumer is an AAA member). As another example, the determination at S820 might be based at least in part on the behavior of other potential consumers. For example, the system might automatically learn over time that male potential customers over the age of fifty prefer to avoid the use of a third-party data source.

If it is determined at S820 that a third-party data source is to be used, then the supplemental data, including vehicle information, is requested and received at S832. An automobile insurance quote is automatically calculated at S834 and displayed to the consumer. The consumer may then validate the data used to generate that quote at S838 and, if needed, the quote may be adjusted for the consumer. Eventually, the consumer may accept the offer from the insurer, and the automobile insurance policy may be issued at S838.

If it is determined at S820 that a third-party data source will not be used, then data about the one or more drivers to be associated with the policy is received at S842 (e.g., he or she will manually enter the information via the insurer's web site). Similarly, data about the one or more vehicles to be associated with the policy is received at S844 along with accident history data (e.g., loss history information) at S848. An automobile insurance quote can then be automatically calculated at S848 and displayed to the consumer. Eventually, the consumer may accept the offer from the insurer, and the automobile insurance policy may be issued at S850.

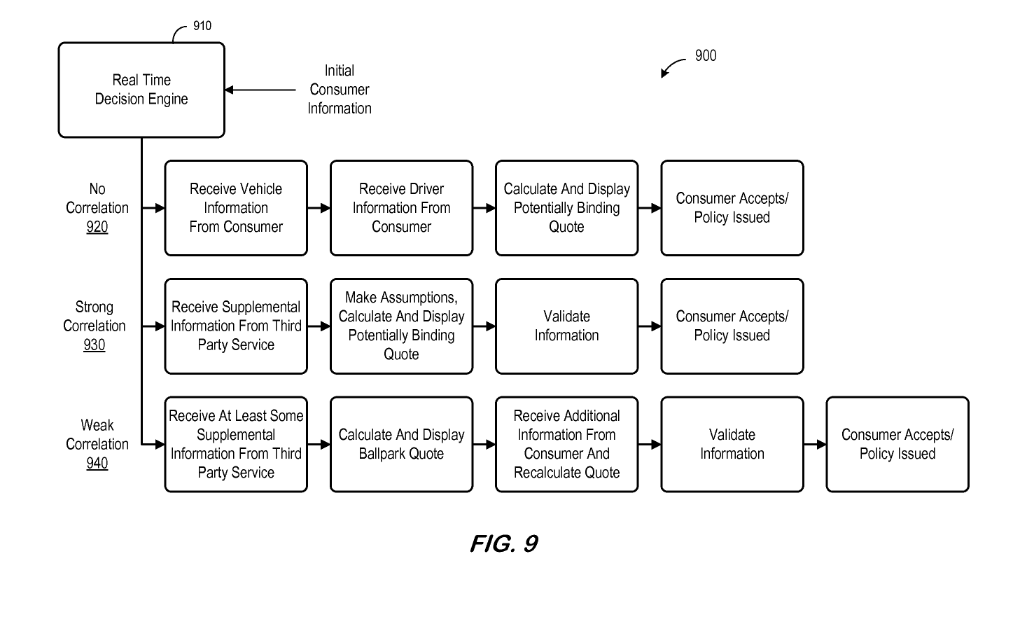

The process 800 described with respect to FIG. 8 assumes that determination made at S820 is a binary decision (the third-party data service will either be used or not be used). Note, however, that other embodiments may be implemented instead. For example, FIG. 9 illustrates various work flows 900 associated with some embodiments disclosed herein. In particular, a real time decision engine 910 may receive initial consumer information from a remote consumer device. The initial consumer information might include, for example, a consumer's name, ZIP code, date of birth, and/or a portion of his or her Social Security number. According to some embodiments, the initial consumer information might include information associated with his or her current location, including, for example, an Internet Protocol (“IP”) address, Global Positioning System (GPS) information, and/or information about a current wireless connection being used by the consumer (e.g., a Wi-Fi access point or wireless telephone tower).

The real time decision engine 910 might then automatically determine that the initial consumer information cannot be automatically correlated with supplemental information. For example, there might be no match between the initial consumer information and data available from a third-party service. In this case, a first work flow 920 might be executed wherein the vehicle information and driver information are manually entered by the consumer. A potentially binding quote may then be calculated and displayed. Eventually, the consumer may accept the offer from the insurer and the automobile insurance policy may be issued.

In some cases, the real time decision engine 910 might instead automatically determine that the initial consumer information can be “strongly” correlated with supplemental information. For example, there might be an exact match between the initial consumer information and data available from a third-party service. In this case, a second work flow 930 might be executed wherein the driver and/or vehicle information are automatically retrieved from the third-party service and a potentially binding quote is immediately calculated and displayed. The consumer may then validate that information, accept the offer from the insurer, and the automobile insurance policy may be issued.

According to some embodiments, the real time decision engine 910 may automatically determine that the initial consumer information can be “weakly” correlated with supplemental information. For example, the consumer's current IP address (or, similarly, a machine address a locally stored Internet browser cookie file) might be used to make certain assumptions about the consumer's home address and/or income. In this case, a third work flow 940 might be executed wherein at least some supplemental information may be automatically retrieved from the third-party service and a “approximate” or “ballpark” quote may be immediately calculated and displayed to the consumer. According to some embodiments, the ballpark quote might represent a range of likely insurance premium values. According to some embodiments, missing data elements or business rules might result in a determination that only a weak correlation exists. For example, a consumer might provide a home address associated with an apartment complex. As a result, records from a DMV server might indicate that fifty vehicles are associated with that address. In this case, a business rule might prevent determination of a strong correlation when more than five vehicles are associated with a potential consumer's home address. The consumer may then provide additional information (e.g., refining the assumptions that were initially made by the insurer) to receive a more accurate quote. When sufficient information has been provided, the consumer may validate the information, accept the offer from the insurer, and the automobile insurance policy may be issued. The refinements and validation performed by the consumer may, according to some embodiments, be used to automatically improve future interactions with other consumers. For example, it might be determined that a predicted vehicle value for consumers in a particular ZIP is usually inaccurate.

According to some embodiments, the workflow 920, 930, 940 is selected by the real time decision engine 910 based at least in part on a weighted scoring algorithm. For example, a score of 0-50 might represent no correlation (in which case the consumer will need to manually enter the information), a score of 50-90 might represent a weak correlation (and a ballpark quote might be displayed), and a score of 90-100 might represent a strong correlation (and a potentially binding quote might be immediately displayed). According to some embodiments, the real time decision engine 910 may use one or more “predictive models” to determine correlation strength. As used herein, the phrase “predictive model” might refer to, for example, any of a class of algorithms that are used to understand relative factors contributing to an outcome, estimate unknown outcomes, discover trends, and/or make other estimations based on a data set of factors collected across prior trials. Note that a predictive model might refer to, but is not limited to, methods such as ordinary least squares regression, logistic regression, decision trees, neural networks, generalized linear models, and/or Bayesian models. A predictive model may trained with historical transaction data, and may be applied to a current interaction with a potential consumer (e.g., to determine whether or not a consumer is likely to be interested in premium prices, a correlation strength between initial consumer data and supplemental data about that consumer, how accurate a potentially binding quote may be, etc.).

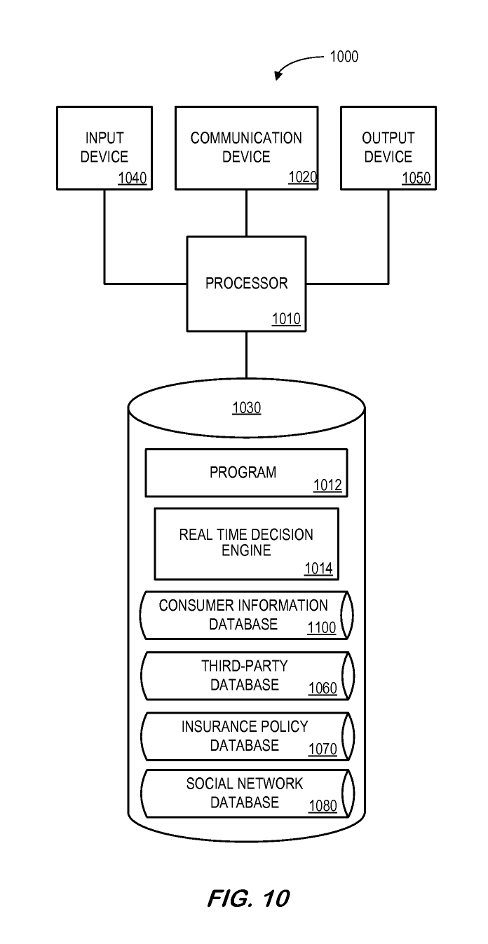

The real time decision engine 910 may be implemented using any number of different hardware configurations. For example, FIG. 10 illustrates an automobile insurance platform 1000 that may be, for example, associated with the systems 100, 900 of FIGS. 1 and 9. The automobile insurance platform 1000 comprises a processor 1010, such as one or more commercially available Central Processing Units (CPUs) in the form of one-chip microprocessors, coupled to a communication device 1020 configured to communicate via a communication network (not shown in FIG. 10). The communication device 1020 may be used to communicate, for example, with one or more remote consumer devices or third-party data services. The automobile insurance platform 1000 further includes an input device 1040 (e.g., a mouse and/or keyboard to enter underwriting rules or decision algorithms) and an output device 1050 (e.g., a computer monitor to display aggregated underwriting results to an administrator).

The processor 1010 also communicates with a storage device 1030. The storage device 1030 may comprise any appropriate information storage device, including combinations of magnetic storage devices (e.g., a hard disk drive), optical storage devices, mobile telephones, vehicle computers, and/or semiconductor memory devices. The storage device 1030 stores a program 1012 and/or real time decision engine 1014 for controlling the processor 1010. The processor 1010 performs instructions of the programs 1012, 1014, and thereby operates in accordance with any of the embodiments described herein. For example, the processor 1010 may receive initial consumer information (not including vehicle information) from a remote consumer device associated with a potential consumer. Responsive to the initial consumer information, the processor 1010 may request and receive supplemental information (including vehicle information) from a third-party data source. An automobile insurance premium may then be calculated for the potential consumer based at least in part on the supplemental information. The processor 1010 may then transmit at least one potentially binding insurance quote to the remote consumer device based on the calculated automobile insurance premium.

The programs 1012, 1014 may be stored in a compressed, uncompiled and/or encrypted format. The programs 1012, 1014 may furthermore include other program elements, such as an operating system, a database management system, and/or device drivers used by the processor 1010 to interface with peripheral devices.

As used herein, information may be “received” by or “transmitted” to, for example: (i) the automobile insurance platform 1000 from another device; or (ii) a software application or module within the automobile insurance platform 1000 from another software application, module, or any other source.

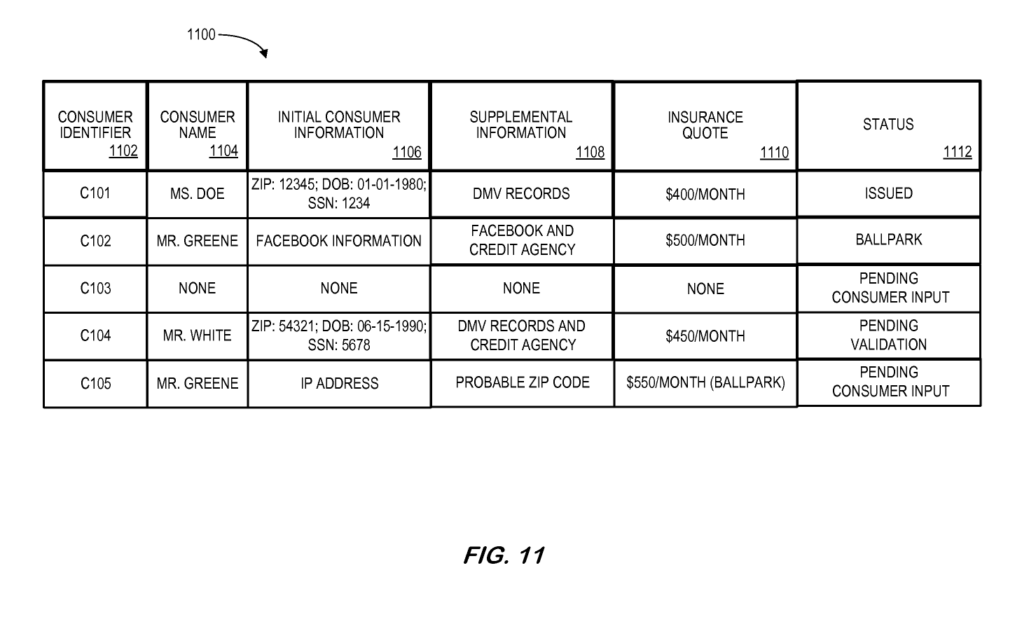

In some embodiments (such as shown in FIG. 10), the storage device 1030 stores a consumer information database 900 (described with respect to FIG. 11), a third-party database 1060 (e.g., storing information received from a DMV or credit agency server), an insurance policy database 1070 (e.g., to help determine if the potential consumer has other policies with the same insurer), and/or a social network database 1080 (e.g., allowing to insurer to access certain information associated with one or more of the consumer's social network accounts).

One example of a consumer information database 1100 that might be used in connection with the automobile insurance platform 1000 will now be described in detail with respect to FIG. 11. Note that the database described herein is only an example, and additional and/or different information may be stored therein. Moreover, various databases might be split or combined in accordance with any of the embodiments described herein.

FIG. 11 is a tabular portion of a consumer information database 1100 according to some embodiments. The table may include, for example, entries identifying consumers interested in receiving automobile insurance quotes from an insurer. The table may also define fields 1102, 1104, 1106, 1108, 1110, 1112 for each of the entries. The fields 1102, 1104, 1106, 1108, 1110, 1112 may, according to some embodiments, specify: a consumer identifier 1102, a consumer name 1104, initial consumer information 1106, supplemental information 1108, insurance quote 1110, and a status 1112. The information in the consumer information database 1100 may be created and updated, for example, whenever data is received from remote consumer and/or third-party data devices.

The consumer identifier 1102 may be, for example, a unique alphanumeric code identifying a consumer who accesses an insurer's web site. The consumer name 1104 and other initial consumer information 1106 might represent information provided by the consumer associated with the consumer identifier 1102. The supplemental information 1108 might, according to some embodiments, include information received from one or more third-party services and/or social network sites. Based on the initial consumer information 1106 and/or supplemental information 1108 the insurance quote 1110 may be automatically calculated (e.g., a potentially binding or ballpark quote). The status 1112 may, for example, indicate the current state of the transaction between the insurer and potential consumer (e.g., the insurer is waiting for the consumer to validate the supplemental information, the policy has already been issued, etc.).

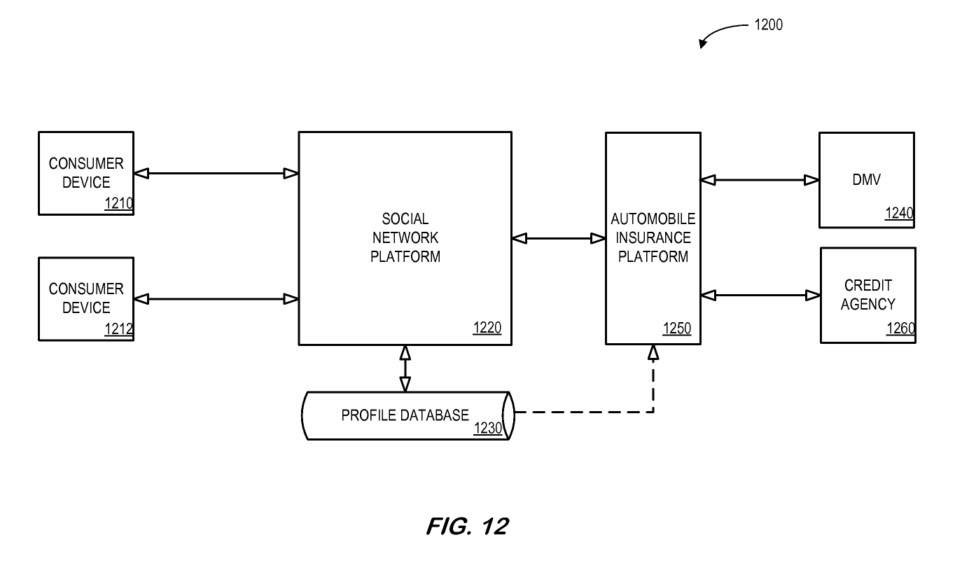

The embodiments described herein may be implemented in any number of different ways. For example, FIG. 12 is a block diagram of a system 1200 according to another embodiment of the present invention. The system 1200 may, for example, facilitate the distribution automobile insurance quotes to potential consumers. In particular, a social media network platform 1220 may receive information from remote consumer devices 1210, such as PCs, laptop computers, and/or wireless telephones and store the information in a local profile database 1230. The social network platform 1220 might be associated with, for example, Facebook, Twitter, LinkedIn, Foursquare, tumblr, YouTube, flickr, digg, last fm, upcoming, mybloglog, slideshare, MySpace, Pandora, and/or a third-party service associated with a plurality of social networks.

According to this embodiment, an automobile insurance platform 1250 may interact with the social network platform 1220 to facilitate a distribution of automobile insurance quote information to remote consumers. For example, the automobile insurance platform 1250 may receive initial consumer information from the social network device 1220 (or directly from the profile databases 1230) and use that data to receive supplemental information from a DMV device 1240 or credit agency device 1260. As other examples, supplemental information might be received from devices associated with a tax agency, a data aggregator, or municipal records. The supplemental information may then be used to calculate and display a potentially binding automobile insurance quote via a consumer device 1210 (e.g., as part of an advertisement, interactive game, add-on application, etc.).

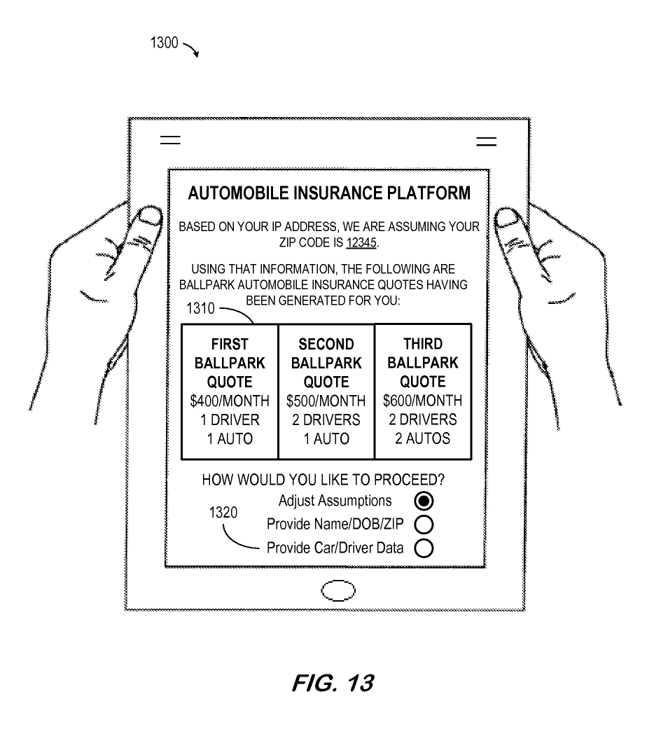

In some cases, the supplemental information may only provided limited information about a potential consumer. For example, a user's profile might only include his or her name and current IP address. FIG. 13 illustrates a display 1300 that might be provided in accordance with some of the embodiments disclosed herein. In this example, the consumer's IP address is used to predict the consumer's home ZIP code. That limited information may be sufficient to calculate and display an estimated or ballpark insurance premium quote 1310 to the consumer. The consumer may then be presented with options 1320, including whether he or she would like to adjust the current assumptions, provide more detailed initial consumer information (e.g., his or her date of birth), or to manually enter vehicle and drive information to receive a potentially binding quote.

Thus, embodiments may provide potential consumers with potentially binding automobile insurance quotes in an efficient and accurate manner. As a result, fewer consumers may abandon the automobile insurance application process.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases described herein may be combined or stored in external systems).

Applicants have discovered that embodiments described herein may be particularly useful in connection with direct interactions with consumers. Note, however, that other types of interactions may also benefit from the invention. For example, embodiments of the present invention may be used in connection with an agent or automobile dealership salesperson who access an automobile insurance platform on behalf of a potential consumer.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A system associated with an insurance enterprise, comprising:
a communication device to receive information from a remote consumer device associated with a potential consumer;
a computer processor for executing program instructions; and
a memory, coupled to the computer processor, for the storing program instructions for execution by the computer processor to:
receive, from the remote consumer device, initial consumer information;
based on the received initial consumer information, request supplemental information from a third-party data source;
receive the supplemental information from the third-party data source;
automatically determine whether: (i) the initial consumer information can be strongly correlated with supplemental information, or (ii) the initial consumer information can only be weakly correlated with the supplemental information;
when it is determined that the initial consumer information can be strongly correlated with the supplemental information:
calculate an insurance premium for the potential consumer based at least in part on the supplemental information, and
transmit, to the remote consumer device, a potentially binding insurance quote based on the calculated insurance premium; and
when it is determined that the initial consumer information can only be weakly correlated with the supplemental information:
calculate an approximate insurance premium for the potential consumer, and
transmit, to the remote consumer device, a non-binding ballpark insurance quote based on the approximate insurance premium.

2. The system of claim 1, the memory further stores program instructions for execution by the computer processor to:
automatically determine whether: (iii) the initial consumer information cannot be automatically correlated with supplemental information at all.

3. The system of claim 1, wherein the initial consumer information comprises at least one of: (i) an Internet protocol address, (ii) a machine address, or (iii) a locally stored Internet browser cookie file.

4. The system of claim 1, wherein the automatic determination is performed based at least in part on a weighted scoring algorithm.

5. The system of claim 1, wherein the automatic determination is performed based at least in part on a business rule and a threshold value.

6. The system of claim 1, wherein the automatic determination is performed based at least in part on a predictive model.

7. A method associated with an insurance enterprise, comprising:
receiving, from a remote consumer device associated with a potential consumer, initial consumer information, wherein the initial consumer information does not include vehicle information;
responsive to said initial consumer information, automatically requesting, by a computer processor, supplemental information from a third-party data source, wherein the request includes the initial consumer information;
receiving the supplemental information from the third-party data source, the supplemental information including vehicle information associated with the potential consumer;
automatically calculating, by the computer processor, an automobile insurance premium for the potential consumer based at least in part on the supplemental information; and
transmitting at least one potentially binding insurance quote from the computer processor to the remote consumer device based on the calculated automobile insurance premium.

8. The method of claim 7, wherein the initial consumer information includes at least two of: (i) a name, (ii) an address, (iii) a ZIP code, (iv) at least a portion of a Social Security number, or (v) a date of birth.

9. The method of claim 7, wherein the supplemental information includes at least one of: (i) a Vehicle Identification Number, (ii) a number of vehicles, (iii) insurance information, (iv) violation information, (v) accident information, (vi) loss information, (vii) information about other drivers associated with the potential consumer, (viii) credit score information, or (ix) income information.

10. The method of claim 7, wherein the third-party data source is associated with at least one of; (i) a governmental department of motor vehicles, (ii) a credit rating agency, (iii) a tax agency, (iv) a data aggregator, or (v) municipal records.

11. The method of claim 7, wherein the automobile insurance premium is further calculated based on at least one of: (i) an affiliation between the potential consumer and a group, or (ii) another insurance policy associated with the potential consumer.

12. The method of claim 7, further comprising:
automatically determining whether the supplemental information is to be received from the third-party data source or the remote consumer device.

13. The method of claim 9, wherein said determination is based at least in part on an affiliation between the potential consumer and a group.

14. The method of claim 13, wherein said determination is based at least in part on the behavior of other potential consumers.

15. The method of claim 7, further comprising:
facilitating an acceptance of the binding insurance quote by the consumer via the remote consumer device, and
issuing an automobile insurance policy to the consumer.

16. The method of claim 7, wherein the remote consumer device comprises at least one of: (i) a personal computer, (ii) a laptop computer, (iii) a hand-held computer, (iv) a wireless device, (v) a smartphone, (vi) a set-top box, or (vii) a kiosk.

17. The method of claim 7, wherein the supplemental information is pre-populated in fields of an insurance application form displayed on the remote consumer device.

18. The method of claim 17, further comprising:
receiving from the consumer a validation of the pre-populated fields.

19. The method of claim 17, further comprising:
receiving from the consumer an adjustment of at least one of the pre-populated fields;
responsive to the adjustment, automatically calculating a modified automobile insurance premium for the potential consumer, and
transmitting, via said communication device, a modified potentially binding insurance quote to the remote consumer device based on the modified automobile insurance premium.

20. The method of claim 7, wherein at least some of the supplemental information is determined based on profile information associated with at least one of: (i) Facebook, (ii) Twitter, (iii) LinkedIn, (iv) Foursquare, (v) tumblr, (vi) YouTube, (vii) flickr, (viii) digg, (ix) last fm, (x) upcoming, (xi) mybloglog, (xii) slideshare, (xiii) MySpace, (xiv) Pandora, or (xv) a third party service associated with a plurality of social networks.

21. A non-transitory computer-readable medium storing instructions adapted to be executed by a computer processor to perform a method, said method comprising:
receiving, from a remote consumer device associated with a potential consumer, initial consumer information, wherein the initial consumer information does not include vehicle information;
responsive to said initial consumer information, automatically requesting supplemental information from a third-party data source, the request including the initial consumer information;
receiving the supplemental information from the third-party data source, the supplemental information including vehicle information associated with the potential consumer;
automatically determining whether: (i) the initial consumer information can be strongly correlated with supplemental information, or (ii) the initial consumer information can only be weakly correlated with the supplemental information;
when it is determined that the initial consumer information can be strongly correlated with the supplemental information:
automatically calculating an automobile insurance premium for the potential consumer based at least in part on the supplemental information, and
transmitting, to the remote consumer device, at least one potentially binding insurance quote based on the calculated automobile insurance premium; and
when it is determined that the initial consumer information can only be weakly correlated with the supplemental information:
automatically calculating an approximate insurance premium for the potential consumer, and
transmitting, to the remote consumer device, a non-binding ballpark insurance quote based on the approximate insurance premium.

22. The medium of claim 21, wherein the initial consumer information includes at least one of: (i) a name, (ii) an address, (iii) a ZIP code, (iv) at least a portion of a Social Security number, or (v) a date of birth.

23. The medium of claim 21, wherein the supplemental information includes at least one of: (i) a Vehicle Identification Number, (ii) a number of vehicles, (iii) insurance information, (iv) violation information, (v) accident information, (vi) loss information, (vii) information about other drivers associated with the potential consumer, (viii) credit score information, or (ix) income information.
